(19) United States
(12) Patent Application Publication
(10) Pub. No.: US 2011/0228832 A1
(43) Pub. Date: Sep. 22, 2011

(54) DEVICE AND METHOD FOR SEARCHING SELECTED FREQUENCY CHANNELS

(75) Inventor: Ruben De Francisco Martin, Utrecht (NL)

(73) Assignee: Stichting IMEC Nederland, Eindhoven (NL)

(21) Appl. No.: 13/048,747

(22) Filed: Mar. 15, 2011

Related U.S. Application Data
(60) Provisional application No. 61/314,025, filed on Mar. 15, 2010.

(30) Foreign Application Priority Data
Jan. 25, 2011 (EP) 11151955.9

(51) Int. Cl. H04B 17/00

(52) U.S. Cl. 375/224

(57) ABSTRACT

A device and method for selecting a frequency channel of given bandwidth in a cognitive radio application is disclosed. In one aspect, the method includes evaluating, at one of a plurality of frequency bins, a function indicative of the frequency occupancy. If the evaluation result indicates free spectrum at the considered frequency bin, the previous step is repeated for a frequency bin adjacent to the considered frequency bin until the free frequency bins constitute a frequency channel of the given bandwidth. Otherwise, the method moves to select a next frequency bin to be considered. It is selected by calculating a measure of the left and right derivative of the function at the considered frequency bin, taking the measure of the left or right derivative as gradient approximation, and determining the next frequency bin by shifting the considered frequency bin over a frequency shift inversely proportional to the gradient approximation.

### CROSS-REFERENCE TO RELATED APPLICATIONS

This application claims priority under 35 U.S.C. §119(e) to U.S. provisional patent application 61/314,025 filed on Mar. 15, 2010, which application is hereby incorporated by reference in its entirety.

### BACKGROUND OF THE INVENTION

1. Field of the Invention

The disclosed technology generally relates to a method and a device for searching frequency channels. It relates in particular to the field of cognitive radios.

2. Description of the Related Technology

In cognitive radios there is a need to increase spectrum usage awareness. In real-time operation, the radio needs a mechanism to find an available channel, with a desired frequency bandwidth BW, which is then used by the cognitive radio to transmit data. One way to achieve this is to apply a spectrum sensing algorithm. Such algorithm is primarily concerned with finding an available channel for transmission rather than obtaining an accurate estimation of the spectrum within a certain frequency range. Hence, it is a task to find white spaces in the spectrum (sometimes also referred to as spectrum holes). The size of the channel may change from radio to radio, depending on the bandwidth needed by the transmission technique used by the cognitive radio.

The spectrum sensing algorithm used depends on the desired performance and complexity, as well as the level of knowledge on the signal that needs to be detected. Popular techniques are matched filter detection, cyclostationarity feature detection, and energy detection. Energy detection is the most extended technique, since signal knowledge at the spectrum sensing device is not required, and has low computational complexity.

In addition, spectrum sensing techniques may be further classified as either wideband or narrowband. Although wideband spectrum sensing has higher complexity than narrowband sensing, an empty channel can be found faster in scenarios with high spectrum occupancy. Typically, the spectrum sensing engine computes a discrete Fourier transform (DFT) on the sampled data, and determines spectrum occupancy in the frequency domain based on a periodogram. A solution to reduce the complexity in such systems is to use compressive sensing, in which spectral estimation is carried out while operating below Nyquist rate. In general, these solutions rely first on a Nyquist sampled signal. Afterwards, assuming that the sampled signal is sparse in frequency, the spectrum can be reconstructed by using a reduced number of DFT coefficients. These techniques require a multiplication by a reconstruction matrix, which reduces the dimensionality of the sampled signal. In addition, it also requires solving at l1-norm minimization problem, which makes these type of solutions still quite complex. In addition, classic compressive sampling techniques provide an estimation of the spectrum shape for the whole band of interest.

There is a need for a spectrum sensing algorithm for use in cognitive radios wherein the computational complexity is reduced.

In patent application US2010/035551 a technique for detecting an unoccupied frequency band is disclosed. The proposed method is based on obtaining values relating to a received signal and determining from those values energy vectors for frequency bands available on the either side of a reference frequency.

US2009/253376 also relates to spectrum sensing in a cognitive radio environment. In the method the search resolution is modified while sensing.

It is thus desirable to provide a method and device for searching a free frequency channel in a cognitive radio with a spectrum sensing algorithm of reduced complexity.

### SUMMARY OF CERTAIN INVENTIVE ASPECTS

A mechanism to search available channels in the frequency domain is proposed, defined as those frequency channels with an arbitrary selectable bandwidth that have energy or amplitude levels below a selectable threshold. By computing only those amplitude/energy frequency domain coefficients needed by the algorithm, the proposed mechanism iteratively looks for a free frequency bin, defined as a frequency bin with energy or amplitude level below a predefined threshold. The search starts at a frequency bin at random, for which the frequency domain coefficient is computed on that bin only, from the sampled input sequence. Based on an approximation on the right and left derivatives of the frequency domain function at the frequency bin searched in the current iteration, the algorithm iteratively searches for a free frequency bin by following the direction of steepest descent. The chosen step-size is such that the algorithm produces large steps in flat spectrum regions and small steps in steep regions, in order not to miss narrow portions of the spectrum with free bins. The algorithm continues until a free frequency bin is found. Once it is found, the algorithm checks if enough adjacent free bins are available to form a free channel. If so, the algorithm stops, otherwise, the algorithm starts randomly at a new frequency bin.

More in particular, one inventive aspect relates to a method for selecting a frequency channel of given bandwidth in a cognitive radio application, wherein the method comprises considering a frequency bin from a plurality of frequency bins and evaluating at the considered frequency bin a function indicative of the frequency occupancy. The method further includes, if the evaluation result indicates free spectrum at the considered frequency bin, repeating the previous step for a frequency bin adjacent to the considered frequency bin until the available free frequency bins constitute a frequency channel of the given bandwidth. The method further includes, if the evaluation result indicates occupied spectrum at the considered frequency bin, performing the step of evaluating for a next frequency bin determined. Evaluating for a next frequency bin determined further includes calculating a measure of the left and right derivative, respectively, of the function at the considered frequency bin, taking the measure of the left or right derivative as gradient approximation depending on which of the two provides the steepest descent, and determining the next frequency bin by shifting the considered frequency bin over a frequency shift inversely proportional to the gradient approximation.

In one aspect, the proposed method indeed allows quickly finding a frequency bin that is free (meaning that that bin is available for communication, i.e. the spectrum occupancy indicating function has a value below a certain threshold level: it is not required that at that frequency no signal level is found/measured at all). By this technique it is possible to move with a large step in a region where the spectrum is relatively flat and to move with a small step where the spectrum is steep and an empty channel may be available in the neighbouring frequency bins.

In a preferred embodiment the frequency shift is proportional to the difference between a maximum and a minimum value of the function indicative of the frequency occupancy. This difference determines a step size value used in the determination of the frequency shift.

Preferably the method further comprises the step of storing the outcome of the evaluating step.

In a preferred embodiment the frequency shift is put equal to a preset fixed value if the gradient approximation exceeds a given threshold.

In an advantageous embodiment the method further comprises a step of keeping a list of already evaluated frequency bins and optionally of the function values found.

In another embodiment the step of evaluating comprises a comparison with a frequency dependent threshold value for determining whether or not there is free spectrum available at the considered frequency bin.

Advantageously, in the function indicative of the frequency occupancy a weighing (also called windowing) of the frequency spectrum is performed. In this way, spectrum leakage can be reduced.

In a particular embodiment the function indicative of the frequency spectrum is given by

$${\hat{S}}_{xx} [ k ] = \frac{1}{M} {\sum }_{m = 0}^{M - 1} {\vert {\sum }_{n = 0}^{N} w [ n ] {x}_{m} ( n ) {e}^{- j2 π nk / N} \vert}^{2} , k = 1 , … , N$$

whereby xₘ is the m-th sampled input signal in the time domain, M the number of coefficient sequences, N the number of frequency bins and w a windowing function.

In a preferred embodiment the method comprises a step of updating at least one parameter value used in the algorithm by setting a refresh variable.

Preferably the refresh variable is externally controllable, i.e. from outside the algorithm.

In another preferred embodiment the given bandwidth is selectable.

In yet another embodiment the method comprises the step of transmitting data in the selected frequency channel of given bandwidth.

The proposed method selects a frequency channel (e.g. an available frequency channel) with a selectable bandwidth in a frequency spectrum. In particular, frequency channels are channels (determined by a predetermined number of bins) with an arbitrary selectable bandwidth that has energy or amplitude levels below a selectable threshold. The method comprises sampling input data (the input data may or may not be windowed in time), setting initial parameters (e.g. search or selection step size, number of adjacent free frequency bins for having a free channel, an energy or amplitude threshold, a number of bins, a number of samples in the time domain, . . . ), selecting a frequency bin, computing and storing an estimate of the frequency domain coefficient in the selected frequency bin and evaluating this coefficient. Dependent on the evaluation result, the selected frequency bin is an element of a selected frequency channel (determines partly a selected or available frequency channel). The method further comprises a set of iterative steps for selecting another available frequency bin (thereby creating the selected frequency channel). The set comprises calculating right and left derivatives of the coefficient at current bin, thereby selecting the direction of the search (based on steepest descent), setting the size of the search step (large in flat spectrum, small in steep spectrum), whereby the size of the step is bounded by a selectable maximum step size value, determining the next frequency bin (using this step size and search direction), computing and storing an estimate of the frequency domain coefficient in the bin, evaluating this coefficient.

In another aspect there is a device for selecting a frequency channel of given bandwidth in a cognitive radio application. The device comprises processor means arranged for evaluating at a considered frequency bin a function indicative of the spectrum occupancy and arranged for, in case there is occupied spectrum at the considered frequency bin, determining a next frequency bin to be evaluated. Determining a next frequency bin to be evaluated includes calculating a measure of the left and right derivative, respectively, of the function at the considered frequency bin, taking the measure of the left or right derivative as gradient approximation depending on which of the two provides the steepest descent, and determining the next frequency bin by shifting the considered frequency bin over a frequency shift inversely proportional to the gradient approximation.

Preferably the device also comprises spectrum detection means.

Advantageously the device further comprises a transmitter for transmitting data in the selected frequency channel of given bandwidth.

### BRIEF DESCRIPTION OF THE DRAWINGS

FIG. 1 illustrates an example of measured spectrum in the ISM band: four 802.11g/WiFi signals and one 802.15.4/ZigBee signal.

FIG. 2 illustrates a computed windowed periodogram with a 1-MHz frequency resolution.

FIG. 3 illustrates the performance with multi-band energy detection using random channel selection and the proposed sequential approach.

FIG. 4 shows the average number of channel searches needed to find an available channel.

FIG. 5 shows a flowchart of one embodiment of a method of selecting a frequency channel of a given bandwidth in a cognitive radio application.

FIG. 6 shows a block diagram illustrating one embodiment of a device for selecting a frequency channel of a given bandwidth in a cognitive radio application.

### DETAILED DESCRIPTION OF CERTAIN ILLUSTRATIVE EMBODIMENTS

The present disclosure will be described with respect to particular embodiments and with reference to certain drawings but the present disclosure is not limited thereto. The drawings described are only schematic and are non-limiting. In the drawings, the size of some of the elements may be exaggerated and not drawn on scale for illustrative purposes.

Furthermore, the terms first, second, third and the like in the description, are used for distinguishing between similar elements and not necessarily for describing a sequential or chronological order. The terms are interchangeable under appropriate circumstances and the embodiments of the present disclosure can operate in other sequences than described or illustrated herein.

Moreover, the terms top, bottom, over, under and the like in the description are used for descriptive purposes and not necessarily for describing relative positions. The terms so used are interchangeable under appropriate circumstances and the embodiments of the present disclosure described herein can operate in other orientations than described or illustrated herein.

The term “comprising” should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting of only components A and B. It means that with respect to the present disclosure, the only relevant components of the device are A and B.

In order to find an available channel within a certain frequency range a spectrum sensing technique for cognitive radios is proposed in one embodiment wherein a discrete Fourier transform (DFT) is computed on the sampled data and spectrum occupancy is determined in the frequency domain. Before computing the DFT, for instance by means of a fast Fourier transform (FFT), the signal may be windowed in the time domain in order to reduce spectrum leakage, using for instance a Hamming window. Next, the frequency spectrum is commonly estimated by means of a smoothed modified periodogram, i.e. by averaging the M latest DFT coefficients as follows:

$${\hat{S}}_{xx} [ k ] = \frac{1}{M} {\sum }_{m = 0}^{M - 1} \vert {\sum }_{n = 0}^{N} w [ n ] {x}_{m} ( n ) {e}^{- j2 π nk / N} {\vert}^{2} , k = 1 , … , N \qquad ( 1 )$$

where xₘ is the m-th sampled input signal in the time domain, with m=1 the most recent sequence and m=M the least recent stored sequence; N is the size of the DFT, w is a window in the time domain, n is the time index of n-th time domain sample, and k is the index of k-th frequency domain coefficient. Different time domain windows may be used, such as a square window, or a Hamming window. Sₓₓ is the vector that contains all frequency domain coefficients, of length N.

In the conventional approach the windowed and smoothed periodogram described above is computed for all frequency bins, k=1, . . . , N. A threshold αₖ is set to decide whether the k-th frequency bin is free (white) or busy (occupied), which may be or not be the same for all frequency bins. If Ŝxx[k]<αₖ, thE frequency bin is free. If Ŝxx[k]≧αₖ, the frequency bin is busy. The described system corresponds to a multi-band (or multi-carrier) energy detector. Depending on the chosen DFT size N, and the sampling rate, M consecutive frequency bins may be needed in order to have an available channel with desired frequency bandwidth BW. Once the N coefficients are computed, the spectrum sensing algorithm may compare the N Ŝxx[k] values, k=1, . . . , N, one by one to the threshold αₖ, to determine what frequency bins are free. Another approach would be to use an arbitrary or predetermined order to search for a free channel; as soon as the algorithm finds a free channel, it stops the search. In both options, which are variations of the conventional approach, the spectrum sensing algorithm needs to compute N Ŝxx[k] coefficients.

In the system described above, since one is just interested in finding only one available channel, it is avoided to compute all N Ŝxx[k] coefficients, with the purpose of reducing algorithmic complexity. The main challenge is to choose the order in which Ŝxx[k] coefficients are computed, in order to have a fast convergence to finding an available channel.

The proposed algorithm addresses the issue of iteratively finding an available channel, computing only a limited number of Ŝxx[k] coefficients and providing fast convergence.

A set-up is considered in which a receiver samples an input signal within a chosen frequency range, yielding a discrete sequence x that contains N symbols. The k-th frequency domain coefficient of the sequence x is represented as follows:

$${\hat{S}}_{xx} [ k ] = \frac{1}{M} {\sum }_{m = 0}^{M - 1} \vert {\sum }_{n = 0}^{N - 1} w [ n ] {x}_{m} [ n ] {e}^{\frac{- j 2 π nk}{N}} {\vert}^{β} \qquad ( 2 )$$

where xₘ is the m-th sampled input signal in the time domain, with m=1 the most recent sequence and m=M the least recent stored sequence; M is the averaging factor, w is a window in the time domain containing N coefficients, n is the time index of n-th time domain sample, and k is the index of k-th frequency domain coefficient. Different time domain windows may be used, such as a square window, triangular window, Hamming window, Hanning window, Bartlett window, Parzen window, Blackman window, etc. The value of β changes the meaning of the frequency domain coefficient. If β=2 is used, the frequency domain coefficient corresponds to that of a smoothed (or averaged) windowed periodogram. Ŝxx[k] is the vector that contains all frequency domain coefficients, of length N.

The above equation (1) denotes a linear representation of a function indicative of the spectrum occupancy. Alternatively, a logarithmic representation may be used. Defined by parameters a, b, c as follows:

$${\hat{S}}_{xx} [ k ] = a {log}_{b} ( \frac{1}{M} {\sum }_{m = 0}^{M - 1} \vert {\sum }_{n = 0}^{N - 1} w [ n ] {x}_{m} [ n ] {e}^{\frac{- j 2 π nk}{N}} {\vert}^{β} ) + c \qquad ( 3 )$$

For the described k-th frequency domain coefficient, the right-side (or forward) derivative approximation with parameter P is defined as follows:

$${∇}_{P}^{R} ( k ) = \frac{{\sum }_{p = 1}^{P} {\hat{S}}_{xx} [ {( k + p )}_{N} ] - P {\hat{S}}_{xx} [ k ]}{P ( P + 1 ) / 2} \qquad ( 4 )$$

where (•)_{N} denotes modulo N. The left-side (or backward) derivative approximation with parameter P is defined as follows:

$${∇}_{P}^{L} ( k ) = \frac{P {\hat{S}}_{xx} [ k ] - {\sum }_{p = 1}^{P} {\hat{S}}_{xx} [ {( k - p )}_{N} ]}{P ( P + 1 ) / 2} \qquad ( 5 )$$

The following definitions are used in the following. max(Z) denotes the maximum value among all elements in the vector Z, whereas min(Z) denotes the minimum value among all elements in the vector Z. For scalars s and t, min(s,t) returns the smallest element, either s or t. sign(s) denotes the sign of the scalar value s. abs(s) denotes the absolute value of the scalar s. round(s) rounds the scalar value s to the nearest integer. K is defined as the number of adjacent free frequency bins needed to have a free available channel.

Before the algorithm starts running, it is assumed that a previous state of all frequency coefficients Ŝxx[k], k=1, . . . , N is stored and available. In addition, the following samples of the input signal are available to the algorithm: xₘ[n], m=1, . . . , M; n=1, . . . , N. [symbol] ← [symbol] ∪kⁱ denotes that the element kⁱ is added to the set of searched indices [symbol] . kⁱ∈ [symbol] means that kⁱ is contained in the set [symbol] , kⁱ∉ [symbol] means that kⁱ is not contained in the set [symbol] . [symbol] denotes a set of K consecutive frequency indices that form the free channel obtained by the algorithm.

The algorithm requires the following input parameters: M, N, w, β, f, P, K and αₖ, k=0, . . . , N−1. If the frequency domain coefficients Ŝxx[k] expressed in logarithmic scale, then a, b, and c are also input parameters. In addition, the following refresh variables are defined: refreshμ, refresh∇^{L} and refresh∇^{R}. These refresh variables are controlled externally (from outside the iterative channel search algorithm) and may be set to either ‘disabled’ or ‘enabled’. Their value may be modified at any time during execution of the algorithm. This allows for extra degrees of freedom in controlling the performance-complexity tradeoff of the proposed algorithm.

The algorithm described in Table 1 is proposed to find an available channel.

As it can be seen in the algorithm description, the search follows always the direction of steepest descent, based on the right and left approximations of the derivative of Ŝxx[k]. The maximum difference between two consecutive channel searches, kⁱ and ^{ki+1}, is limited to N/f (f is just a value used to limit the maximum step size). In one embodiment the maximum step size is defined as N/f (the difference between kⁱ⁺¹ and kⁱ), so that f determines the fraction of the total number of frequency bins). As soon as the algorithm finds a set of frequency bins [symbol] with Ŝxx[k]<αₖ ∀k∈ [symbol] , the search ends.

Next, some simulation results are presented to illustrate that the proposed channel search algorithm outperforms prior art solutions. The performance and algorithm complexity is compared to that of a system that employs random channel search until a free channel is found. The simulated network corresponds to the ISM band, in the 2400-2485 MHz range. 86 1-MHz channels are considered, centered at 2400, 2401, . . . , 2485. In the simulated scenario, shown in FIG. 1, four WiFi (IEEE 802.11g) networks and one ZigBee (IEEE 802.15.4) network are present at all times, without changing transmission power and center frequencies.

In the simulated system the logarithmic representation of Ŝxx[k] has been used, with parameters a=10, b=10, and c=0, and β=2. This corresponds to a smoothed windowed periodogram expressed in dBw per frequency unit:

$${\hat{S}}_{xx} [ k ] = 10 {log}_{10} ( \frac{1}{M} {\sum }_{m = 0}^{M - 1} \vert {\sum }_{n = 0}^{N - 1} w [ n ] {x}_{m} [ n ] {e}^{\frac{- j 2 π nk}{N}} {\vert}^{2} ) \qquad ( 6 )$$

TABLE 1
Proposed iterative channel search algorithm

Initialization
1) Initialize i = 1
2) Initialize step-size value: $μ = \frac{2 [ max ( ) - min ( ) ]}{P + 1}$
3) Set kⁱ to a random value between 0 and N − 1
4) Initialize set of searched indices [symbol] = {kⁱ}
5) Compute and store [symbol] [kⁱ]
6) If [symbol] [kⁱ] ≧ αₖ_{ⁱ}, go to step 8); otherwise, go to step 7)
7) Find a set [symbol] _{free} with K frequency indices adjacent to kⁱ. that contains kⁱ,

such that [symbol] [k] < αₖ∀k ε [symbol] _{free}: Compute and store [symbol] [k]∀k ε [symbol]
as soon as set is found. the algorithm ends;
if such a set of size K can not be found. go to step 8)

Iterate, until i equals N − 1

| 8) If refresh∇^{R} is enabled, compute and store | |
|---|---|
| | [symbol] [p], p (kⁱ + 1)_{N}, (kⁱ + 2)_{N}, . . ., (kⁱ + P)_{N}; |
| | otherwise, go to step 10) |
| 9) If [symbol] [p] < αₚ for any p (kⁱ + 1)_{N}, (kⁱ + 2)_{N}, . . ., (kⁱ + P)_{N}, | |
| | and p ∉ [symbol] , set kⁱ⁺¹ = p and go to step 21) |
| 10) Compute ${∇}_{P}^{R} ( {k}^{i} ) = \frac{{\sum }_{p = 1}^{p} [ {( {k}^{i} + p )}_{N} ] - P [ {k}^{i} ]}{P ( P + 1 ) / 2}$ | |
| 11) If refresh∇^{L} is enabled, compute and store | |
| | [symbol] [p], p = (kⁱ − 1)_{N}, (kⁱ − 2)_{N}, . . ., (kⁱ − P)_{N}; |
| | otherwise, go to step 13) |
| 12) If [symbol] [p] < αₚ for any p = (kⁱ − 1)_{N}, (kⁱ − 2)_{N}, . . ., (kⁱ − P)_{N}. | |
| | and p ∉ [symbol] , set kⁱ⁺¹ = p and go to step 21) |
| 13) Compute ${∇}_{P}^{L} ( {k}^{i} ) = \frac{P [ {k}^{i} ] - {\sum }_{p = 1}^{p} [ {( {k}^{i} - p )}_{N} ]}{P ( P + 1 ) / 2}$ | |
| 14) If sign (∇_{P}^{L}(kⁱ)) equals sign(∇_{P}^{R}(kⁱ)), go to step 15); | |
| | otherwise, go to step 16) |
| 15) If sign (∇_{P}^{L}(kⁱ)) is positive, then direction = −1 and ∇(kⁱ) = ∇_{P}^{L}(kⁱ); | |
| | otherwise, direction = 1 and ∇(kⁱ) = ∇_{P}^{R}(kⁱ) |
| 16) If abs (∇_{P}^{L}(kⁱ)) > abs(∇_{P}^{R}(kⁱ)), then direction = −1 and ∇(kⁱ) = ∇_{P}^{L}(kⁱ); | |
| | otherwise, direction = 1 and ∇(kⁱ) = ∇_{P}^{R}(kⁱ) |
| 17) If $( \frac{μ}{∇ ( {k}^{i} )} ) < \frac{N}{f} , then Δ = \frac{μ}{∇ ( {k}^{i} )} ;$ | |
| | otherwise, $Δ = - direction \times \frac{N}{f}$ |
| 18) Set kⁱ⁺¹ = (round(kⁱ − Δ))_{N} | |
| 19) If kⁱ⁺¹ ε [symbol] , then go to step 16); otherwise, go to step 17) | |
| 20) As long as kⁱ⁺¹ ε [symbol] , set kⁱ⁺¹ = (kⁱ⁺¹ + direction)_{N}; stop when kⁱ⁺¹ ∉ [symbol] | |
| 21) Add index to set of searched indices [symbol] ← [symbol] ∪ kⁱ⁺¹ | |
| 22) Compute and store [symbol] [kⁱ⁺1] | |
| 23) If [symbol] [kⁱ⁺¹] ≧ αₖ_{ⁱ⁺¹}, go to step 25); otherwise, go to step 24) | |
| 24) Find a set [symbol] _{free} with K frequency indices adjacent to kⁱ⁺¹, that contains | |
| | kⁱ⁺¹, such that [symbol] [k] < αₖ∀k ε [symbol] _{free}; Compute and store [symbol] [k]∀k ε |
| | [symbol] _{free}; as soon as such set is found, the algorithm ends; |
| | if such a set if size K can not be found, go to step 25) |

25) If Refreshμ is enabled, update $μ = \frac{2 [ max ( ) - min ( ) ]}{P + 1}$
26) Set i = i + 1

Each frequency bin corresponds to a bandwidth of 1 MHz (1-MHz frequency resolution), which is considered in this example also as the necessary bandwidth to form a free channel, i.e. K=1. A summary of all system parameters used in this simulation is provided in Table 2, which are parameters required by the proposed algorithm. A sampling rate of 172 MHz (2×86 MHz) has been used. Note that, for this choice of parameters, the algorithm limits the maximum step between consecutive searches to N/16. In this case, the 3 refresh variables have been set to 0. In a practical system, a refreshing rate may be defined in order to set the refresh variables (refreshμ, refresh∇^{L}, and refresh∇^{R}) to enabled periodically, e.g. every 10, 100 or 1000 ms, or after a certain number of spectrum sensing observations. Also, for simplicity, αₖ=α, k=1, . . . , N has been used. For each SNR value in the simulation, a is chosen such that P_{fa} (probability of false alarm) values are obtained below 10%, while providing high P_{d} (probability of detection), both for the proposed approach and the random channel search approach.

TABLE 2
Simulation parameters

| Parameter | Value |
|---|---|
| a | 10 |
| b | 10 |
| c | 0 |
| M | 1 |
| N | 86 |
| w | Hamming |
| β | 2 |
| f | 16 |
| P | 2 |
| K | 1 |
| refreshμ | 0 |
| refresh∇^{L} | 0 |
| refresh∇^{R} | 0 |

For this particular choice of system parameters, the proposed algorithm can be simplified. This is particularly due to the fact that the refresh variables are disabled and K=1. The resulting simplified (equivalent) algorithm is provided in Table 3. Table 3 summarizes the main benefits contributed by the proposed algorithm: heuristics to find the best direction (steps 14-16), formula to set kⁱ⁺¹ from kⁱ (steps 17-18), and computation of the step-size μ (step 2).

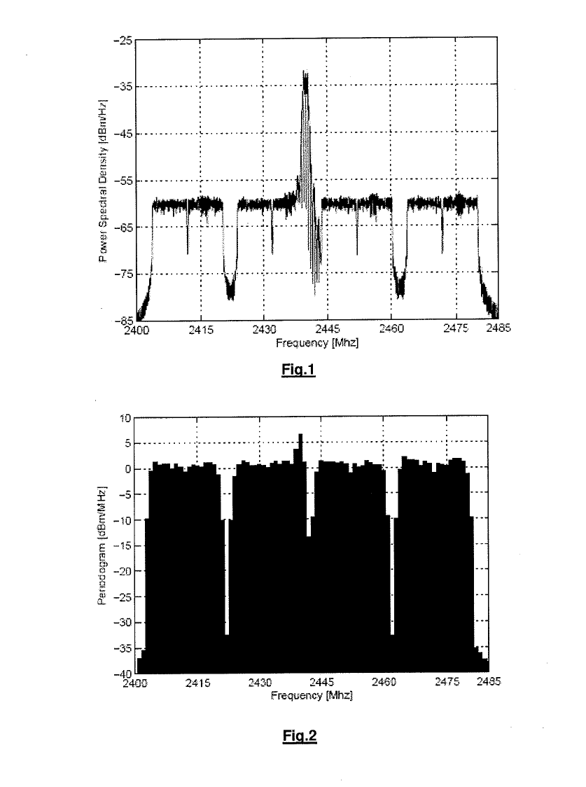

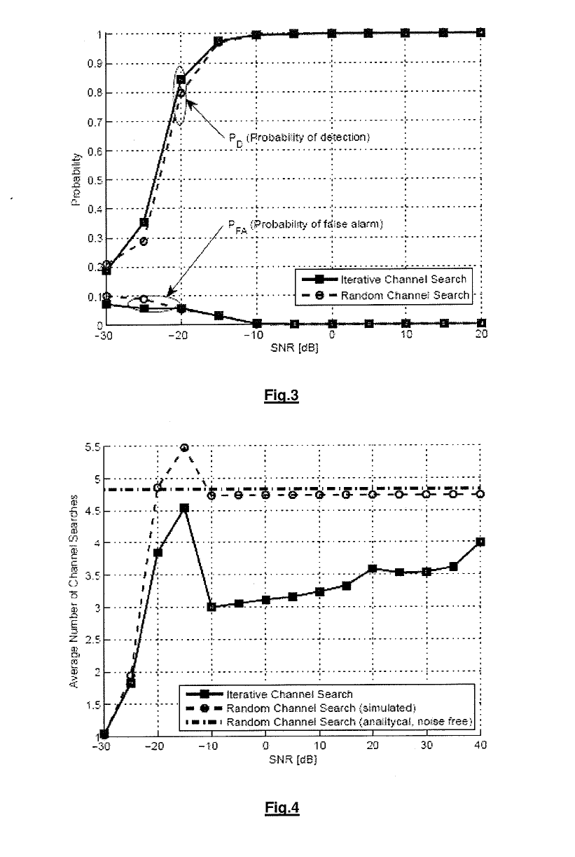

After computing the smoothed windowed periodogram with the mentioned system parameters, the resulting periodogram (for the full range of interest) is depicted in FIG. 2. The performance in terms of P_{d} and P_{fa} is shown in FIG. 3. As it can be observed, the performance of the proposed and random approaches is quite similar as expected. This is due to the fact that the performance is limited by that of the detection technique used: energy detection.

TABLE 3
Simplified iterative channel search algorithm for the simulated scenario

Initialization
1) Initialize i = 1
2) Initialize step-size value: $μ = \frac{2 [ max ( ) - min ( ) ]}{P + 1}$
3) Set kⁱ to a random value between 0 and N − 1
4) Initialize set of searched indices [symbol] = {kⁱ}
5) Compute and store [symbol] [kⁱ]
6) If [symbol] [kⁱ] ≧ αₖ_{ⁱ}, go to step 8); otherwise, the algorithm ends
Iterate, until i equals N − 1

| 10) Compute ${∇}_{P}^{R} ( {k}^{i} ) = \frac{{\sum }_{p = 1}^{p} [ {( {k}^{i} + p )}_{N} ] - P [ {k}^{i} ]}{P ( P + 1 ) / 2}$ | |
|---|---|
| 13) Compute ${∇}_{P}^{L} ( {k}^{i} ) = \frac{P [ {k}^{i} ] - {\sum }_{p = 1}^{p} [ {( {k}^{i} - p )}_{N} ]}{P ( P + 1 ) / 2}$ | |
| 14) If sign(∇_{P}^{L}(kⁱ)) equals sign(∇_{P}^{L}(kⁱ)), go to step 15); | |
| | otherwise go to step 16) |
| 15) If sign(∇_{P}^{L}(kⁱ)) is positive. then direction = −1 and ∇(kⁱ) = ∇_{P}^{L}(kⁱ); | |
| | otherwise, direction = 1 and ∇(kⁱ) = ∇_{P}^{R}(kⁱ) |
| 16) If abs(∇_{P}^{L}(kⁱ)) > abs(∇_{P}^{R}(kⁱ)), then direction = −1 and ∇(kⁱ) = ∇_{P}^{L}(kⁱ); | |
| | otherwise, direction = 1 and ∇(ki) = ∇_{P}^{R}(kⁱ) |
| 17) If $( \frac{μ}{∇ ( {k}^{i} )} ) < \frac{N}{f} , then Δ = \frac{μ}{∇ ( {k}^{i} )} ;$ | |
| | otherwise, $Δ = - direction \times \frac{N}{f}$ |

18) Set kⁱ⁺¹ = (round(kⁱ − Δ))_{N}
19) If kⁱ⁺¹ ε [symbol] , then go to step 16); otherwise, go to step 17)
20) As long as kⁱ⁺¹ ε [symbol] , set kⁱ⁺¹ = (kⁱ⁺¹ + direction)_{N}; stop when kⁱ⁺¹ ∉ [symbol]
21) Add index to set of searched indices [symbol] ← [symbol] ∪ kⁱ⁺¹
22) Compute and store [symbol] [kⁱ⁺¹]
23) If [symbol] [kⁱ⁺¹] ≧ αₖ_{ⁱ⁺¹}, go to step 26); otherwise, the algorithm ends;
26) Set i = i + 1

In the proposed algorithm a complexity reduction can be obtained. First of all, note that only the subset of spectrum coefficients needed by the algorithm is computed, which is much lower in average than the complexity of a system that computes all N=86 coefficients at each spectrum sensing operation. The complexity of the proposed algorithm, in terms of the average number of channel searches needed to find a free channel, is shown in FIG. 4. Note that in most cases four different searches (iterations in the algorithm) are carried out in average at most, which is much lower than that of the full complexity (conventional system) with 86 coefficient computations (in this particular system). A considerable gain is also shown here when compared to the random search approach. In fact, the number of searches needed with random search dramatically increases as the proportion [free channels]/[total channels] decreases. This makes random channel search quite impractical in situations where the spectrum is very crowded (as often seen in the ISM band). In the low SNR region, although a channel is found quickly, the channel is often not free (missed detection event), since due to the poor SNR conditions the energy detector makes an error.

In one embodiment, the proposed approach is thus a fast converging algorithm that can greatly reduce the complexity of the spectrum sensing task, in systems that combine multiband sensing and energy detection. The algorithm is especially helpful in scenarios with a limited number of available channels.

One particularly interesting application field of the proposed sensing method is that of body area networks. Medical body area networks (MBAN) are a key technology to provide wireless connectivity to healthcare services. In the near future, these technologies may operate in frequency ranges where the status of secondary service will be granted, such as the 2360-2400 MHz band in the United States and the 2483.5-2500 MHz band in Europe. Future MBAN radios operating in these bands will need to employ listen-before-talk (LBT) mechanisms in order to coexist with primary users without harmful interference, meaning that spectrum sensing is carried out before transmission.

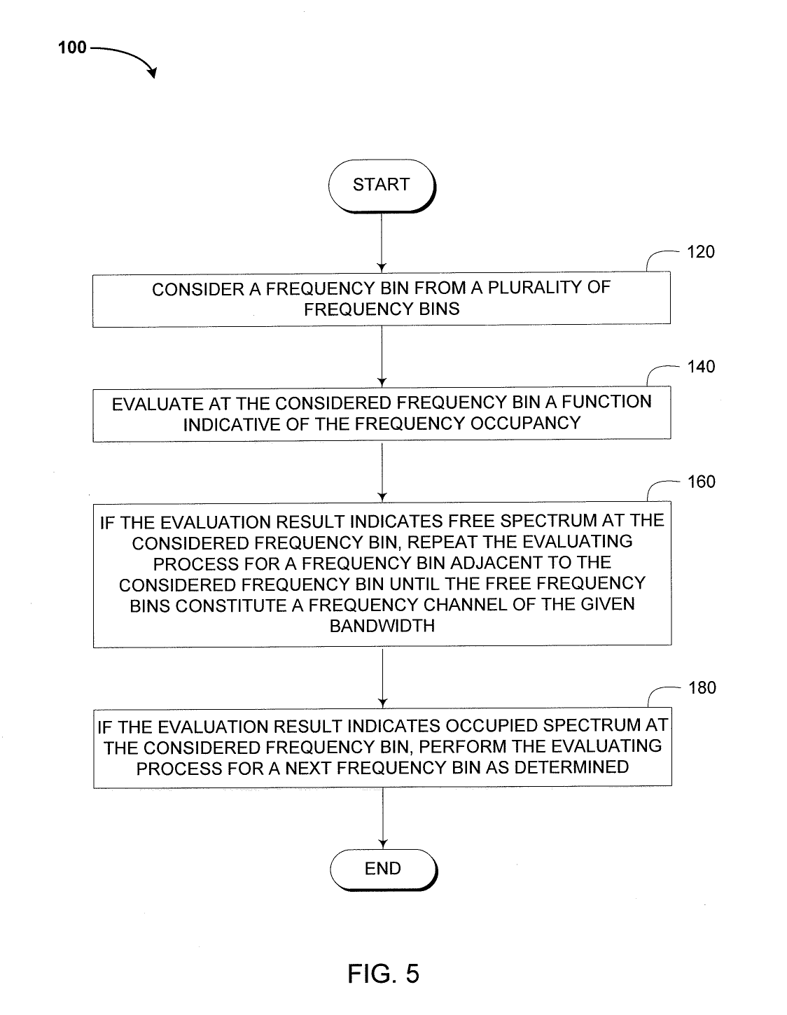

FIG. 5 shows a flowchart of one embodiment of a method of selecting a frequency channel of a given bandwidth in a cognitive radio application. Depending on the embodiment, certain blocks of the method may be removed, merged together, or rearranged in order. The blocks of the method may be performed by, for example, a processor.

The method 100 starts at a block 120, wherein a frequency bin from a plurality of frequency bins is considered. Moving to a block 140, the method includes evaluating at the considered frequency bin a function indicative of the frequency occupancy. The method performs block 160 or block 180 depending on the evaluation result of block 140. If the evaluation result indicates free spectrum at the considered frequency bin, the method includes, at block 160, repeating the evaluating process for a frequency bin adjacent to the considered frequency bin until the free frequency bins constitute a frequency channel of the given bandwidth.

If the evaluation result indicates occupied spectrum at the considered frequency bin, the method includes, at block 180, performing the evaluating process for a next frequency bin. At block 180, the next frequency bin may be determined by (a) calculating a measure of a left and right derivative, respectively, of the function at the considered frequency bin, (b) taking the measure of the left or right derivative as gradient approximation depending on which of the two provides the steepest descent, and then (c) determining the next frequency bin by shifting the considered frequency bin over a frequency shift inversely proportional to the gradient approximation.

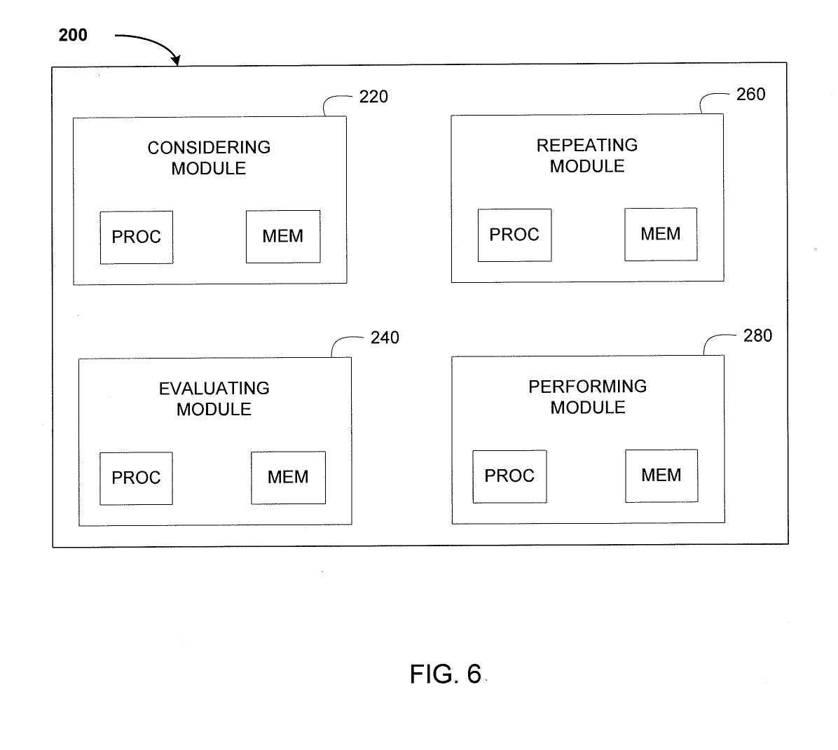

FIG. 6 shows a block diagram illustrating one embodiment of a device for selecting a frequency channel of a given bandwidth in a cognitive radio application. The device 200 comprises a considering module 220 configured to consider a frequency bin from a plurality of frequency bins. The device may further comprise an evaluating module 240 configured to evaluate at the considered frequency bin a function indicative of the frequency occupancy. The device may further comprise a repeating module 260 configured to repeat the evaluating process for a frequency bin adjacent to the considered frequency bin until the free frequency bins constitute a frequency channel of the given bandwidth, if the evaluation result indicates free spectrum at the considered frequency bin.

The device may further comprise a performing module 280 configured to perform the evaluating process for a next frequency bin, if the evaluation result indicates occupied spectrum at the considered frequency bin. The next frequency bin may be determined by (a) calculating a measure of a left and right derivative, respectively, of the function at the considered frequency bin, (b) taking the measure of the left or right derivative as gradient approximation depending on which of the two provides the steepest descent, and then (c) determining the next frequency bin by shifting the considered frequency bin over a frequency shift inversely proportional to the gradient approximation.

In one embodiment, any of the modules 220, 240, 260, and 280 may optionally comprise a processor and/or a memory. In another embodiment, one or more processors and/or memories may be external to one or both modules. Furthermore, a computing environment may contain a plurality of computing resources which are in data communication.

Although systems and methods as disclosed, is embodied in the form of various discrete functional blocks, the system could equally well be embodied in an arrangement in which the functions of any one or more of those blocks or indeed, all of the functions thereof, are realized, for example, by one or more appropriately programmed processors or devices.

It is to be noted that the processor or processors may be a general purpose, or a special purpose processor, and may be for inclusion in a device, e.g., a chip that has other components that perform other functions. Thus, one or more aspects of the present invention can be implemented in digital electronic circuitry, or in computer hardware, firmware, software, or in combinations of them. Furthermore, aspects of the invention can be implemented in a computer program product stored in a computer-readable medium for execution by a programmable processor. Method steps of aspects of the invention may be performed by a programmable processor executing instructions to perform functions of those aspects of the invention, e.g., by operating on input data and generating output data. Accordingly, the embodiment includes a computer program product which provides the functionality of any of the methods described above when executed on a computing device. Further, the embodiment includes a data carrier such as for example a CD-ROM or a diskette which stores the computer product in a machine-readable form and which executes at least one of the methods described above when executed on a computing device.

The foregoing description details certain embodiments of the present disclosure. It will be appreciated, however, that no matter how detailed the foregoing appears in text, the present disclosure may be practiced in many ways. It should be noted that the use of particular terminology when describing certain features or aspects of the present disclosure should not be taken to imply that the terminology is being re-defined herein to be restricted to including any specific characteristics of the features or aspects of the present disclosure with which that terminology is associated.

While the above detailed description has shown, described, and pointed out novel features of the present disclosure as applied to various embodiments, it will be understood that various omissions, substitutions, and changes in the form and details of the device or process illustrated may be made by those skilled in the technology without departing from the scope of the present disclosure. The scope of the invention is indicated by the appended claims rather than by the foregoing description. All changes which come within the meaning and range of equivalency of the claims are to be embraced within their scope.

What is claimed is:

1. A method of selecting a frequency channel of a given bandwidth in a cognitive radio application, the method comprising:
considering a frequency bin from a plurality of frequency bins;
evaluating at the considered frequency bin a function indicative of the frequency occupancy;
if the evaluation result indicates free spectrum at the considered frequency bin, repeating the evaluating process for a frequency bin adjacent to the considered frequency bin until the free frequency bins constitute a frequency channel of the given bandwidth,
if the evaluation result indicates occupied spectrum at the considered frequency bin, performing the evaluating process for a next frequency bin, the next frequency bin being determined by:
calculating a measure of a left and right derivative, respectively, of the function at the considered frequency bin,
taking the measure of the left or right derivative as gradient approximation depending on which of the two provides the steepest descent,
determining the next frequency bin by shifting the considered frequency bin over a frequency shift inversely proportional to the gradient approximation.

2. The method of selecting as in claim 1, wherein the frequency shift is proportional to the difference between a maximum and a minimum value of the function indicative of the frequency occupancy.

3. The method of selecting as in claim 1, further comprising storing the outcome of the evaluating process.

4. The method of selecting as in claim 1, wherein if the gradient approximation exceeds a given threshold, the frequency shift equals a preset fixed value.

5. The method of selecting as in claim 1, further comprising keeping a list of evaluated frequency bins.

6. The method of selecting as claim 1, wherein of the process of evaluating comprises a comparison with a frequency dependent threshold value for determining whether or not there is free spectrum at the considered frequency bin.

7. The method of selecting as in claim 1, wherein in the function indicative of the frequency occupancy a weighing of the frequency spectrum is performed.

8. The method of selecting as in claim 7, wherein the function indicative of the frequency spectrum is given by
$${\hat{S}}_{xx} [ k ] = \frac{1}{M} {\sum }_{m = 0}^{M - 1} \vert {\sum }_{n = 0}^{N - 1} w [ n ] {x}_{m} [ n ] {e}^{- j 2 π nk} {\vert}^{2} , k = 1 , … , N$$
whereby xₘ is the m-th sampled input signal in the time domain, M the number of coefficient sequences, N the number of frequency bins and w a windowing function.

9. The method of selecting as in claim 1, comprising updating at least one parameter value by setting a refresh variable.

10. The method of selecting as in claim 9, wherein the refresh variable is controllable.

11. The method of selecting as in claim 9, wherein the given bandwidth is selectable.

12. The method of selecting as in claim 1, further comprising transmitting data in the selected frequency channel of given bandwidth.

13. The method of selecting as in claim 1, wherein the method is performed by one or more computing devices.

14. A non-transitory computer-readable medium having stored therein a program which, when executed on a processor, performs the method of claim 1.

15. A device for selecting a frequency channel of a given bandwidth in a cognitive radio application, the device comprising:
a storage unit; and
a processor coupled to the storage unit and configured to evaluate at a considered frequency bin a function indicative of the spectrum occupancy and to, in case there is occupied spectrum at the considered frequency bin, determine a next frequency bin to be evaluated by performing:
calculating a measure of a left and right derivative, respectively, of the function at the considered frequency bin,
taking the measure of the left or right derivative as gradient approximation depending on which of the two provides the steepest descent, and
determining the next frequency bin by shifting the considered frequency bin over a frequency shift inversely proportional to the gradient approximation.

16. The device for selecting as in claim 15, further comprising a spectrum detection module.

17. The device for selecting as in claim 15, further comprising a transmitter configured to transmit data in the selected frequency channel of given bandwidth.

18. The device for selecting as in claim 15, wherein in the function indicative of the frequency occupancy a weighing of the frequency spectrum is performed.

19. The device for selecting as in claim 18, wherein the function indicative of the frequency spectrum is given by
$${\hat{S}}_{xx} [ k ] = \frac{1}{M} {\sum }_{m = 0}^{M - 1} \vert {\sum }_{n = 0}^{N - 1} w [ n ] {x}_{m} [ n ] {e}^{- j 2 π nk} {\vert}^{2} , k = 1 , … , N$$
whereby xₘ is the m-th sampled input signal in the time domain, M the number of coefficient sequences, N the number of frequency bins and w a windowing function.

20. A device for selecting a frequency channel of a given bandwidth in a cognitive radio application, the device comprising:
means for considering a frequency bin from a plurality of frequency bins;
means for evaluating at the considered frequency bin a function indicative of the frequency occupancy;
means for repeating the evaluating process for a frequency bin adjacent to the considered frequency bin until the free frequency bins constitute a frequency channel of the given bandwidth, if the evaluation result indicates free spectrum at the considered frequency bin; and
means for performing the evaluating process for a next frequency bin, if the evaluation result indicates occupied spectrum at the considered frequency bin, the next frequency bin being determined by:
calculating a measure of a left and right derivative, respectively, of the function at the considered frequency bin,
taking the measure of the left or right derivative as gradient approximation depending on which of the two provides the steepest descent,
determining the next frequency bin by shifting the considered frequency bin over a frequency shift inversely proportional to the gradient approximation.
